(19) United States
(12) Patent Application Publication
(10) Pub. No.: US 2021/0107362 A1
(43) Pub. Date: Apr. 15, 2021

(54) VEHICLE

(71) Applicant: TOYOTA JIDOSHA KABUSHIKI KAISHA, Toyota-shi (JP)

(72) Inventor: Ryosuke OSUGI, Toyota-shi (JP)

(73) Assignee: TOYOTA JIDOSHA KABUSHIKI KAISHA, Toyota-shi (JP)

(21) Appl. No.: 16/987,382

(22) Filed: Aug. 6, 2020

(30) Foreign Application Priority Data
Oct. 15, 2019 (JP) 2019-188602

(51) Int. Cl. B60L 50/15; B60L 3/00

(52) U.S. Cl. CPC B60L 50/15; B60L 2240/44; B60L 3/0046

(57) ABSTRACT

A vehicle includes a motor, an inverter configured to drive the motor, an electric power storage device connected to the inverter through a power line, and a control device configured to control the inverter. When zero torque control for controlling the inverter such that torque of the motor becomes zero is executed, the control device is configured to control the inverter using a carrier frequency higher than when the zero torque control is not executed.

### INCORPORATION BY REFERENCE

The disclosure of Japanese Patent Application No. 2019-188602 filed on Oct. 15, 2019 including the specification, drawings and abstract is incorporated herein by reference in its entirety.

### BACKGROUND

### 1. Technical Field

The present disclosure relates to a vehicle, and in particular, to a vehicle including a motor, an inverter, and an electric power storage device.

### 2. Description of Related Art

Hitherto, as such a kind of vehicle, a vehicle including an electric motor, an inverter, and an electric power storage device has been suggested (for example, see Japanese Unexamined Patent Application Publication No. 2018-70033 (JP 2018-70033 A)). In the vehicle, when the electric motor does not need to be driven, and when a counter electromotive voltage of the electric motor is higher than a voltage on the electric power storage device side, zero torque control for controlling the inverter by setting a voltage command of the electric motor such that output torque from the electric motor becomes a value zero is executed.

### SUMMARY

In such a vehicle, a ripple of a current supplied to the motor occurs with switching of a plurality of switching elements of the inverter, and sound radiation (carrier noise) occurs. Then, it is assumed that a driver is likely to feel carrier noise, which occurs when the zero torque control is executed, as noise.

A vehicle of the present disclosure primarily aims to suppress carrier noise when zero torque control is executed.

In order to achieve the above-described primary object, the vehicle of the present disclosure is implemented by an aspect described below.

A first aspect of the present disclosure relates to a vehicle. The vehicle includes a motor, an inverter, an electric power storage device, and a control device. The inverter is configured to drive the motor. The electric power storage device is connected to the inverter through a power line. The control device is configured to control the inverter. The control device is configured to, when zero torque control for controlling the inverter such that torque of the motor becomes zero is executed, control the inverter using a carrier frequency higher than when the zero torque control is not executed.

In the vehicle of the present disclosure, when the zero torque control for controlling the inverter such that the torque of the motor becomes zero is executed, the inverter is controlled using the carrier frequency higher than when the zero torque control is not executed. With this, carrier noise when the zero torque control is executed can be suppressed. To begin with, when the zero torque control is not executed, loss due to switching of a plurality of switching elements of the inverter can be reduced.

In the vehicle of the present disclosure, the control device may be configured to, when the zero torque control is executed in controlling the inverter through asynchronous pulse width modulation control, control the inverter using the carrier frequency higher than when the zero torque control is not executed.

In the vehicle of the present disclosure, the control device may be configured to execute the zero torque control when a shift position is a neutral position and a counter electromotive voltage generated with rotation of the motor is higher than a voltage of the power line. With this, carrier noise when the zero torque control is executed at the neutral position can be suppressed.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a configuration diagram showing the outline of the configuration of an electric vehicle 20 as an example of the present disclosure;

FIG. 2 is a flowchart showing an example of a carrier frequency setting routine that is executed by an electronic control unit 50;

FIG. 3 is a configuration diagram showing the outline of the configuration of a hybrid vehicle 120 of a modification example;

FIG. 4 is a configuration diagram showing the outline of the configuration of a hybrid vehicle 220 of a modification example;

FIG. 5 is a configuration diagram showing the outline of the configuration of a hybrid vehicle 320 of a modification example;

FIG. 6 is a configuration diagram showing the outline of the configuration of a fuel cell vehicle 420 of a modification example; and

FIG. 7 is a configuration diagram showing the outline of the configuration of an electric vehicle 520 of a modification example.

### DETAILED DESCRIPTION OF EMBODIMENTS

Next, a mode for carrying out the present disclosure will be described in connection with an example.

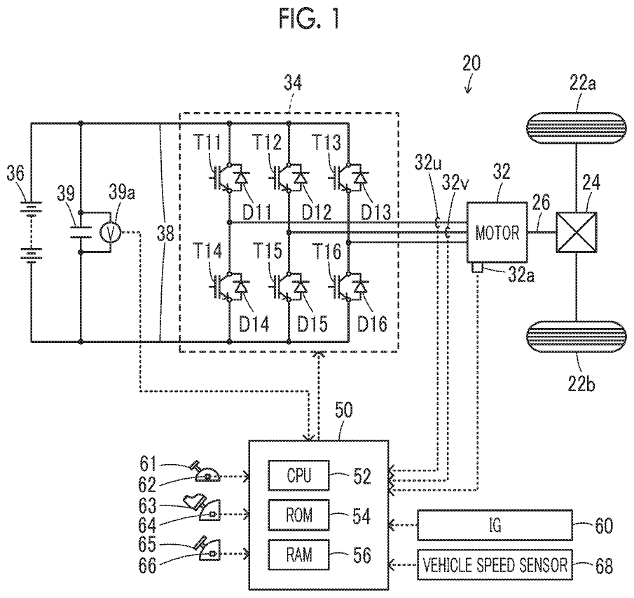

FIG. 1 is a configuration diagram showing the outline of the configuration of an electric vehicle 20 as an example of the present disclosure. As shown in the drawing, the electric vehicle 20 of the example includes a motor 32, an inverter 34, a battery 36 as an electric power storage device, and an electronic control unit 50.

The motor 32 is constituted as a synchronous motor generator, and includes a rotor in which a permanent magnet is embedded in a rotor core, and a stator in which three-phase coils are wound around a stator core. The rotor of the motor 32 is connected to a drive shaft 26 coupled to drive wheels 22a, 22b through a differential gear 24.

The inverter 34 is used to drive the motor 32, is connected to the battery 36 through a power line 38, and has six transistors T11 to T16 as a switching element, and six diodes D11 to D16 connected in parallel to the six transistors T11 to T16, respectively. The transistors T11 to T16 are disposed in pairs so as to become a source side and a sink side with respect to a positive electrode side line and a negative electrode side line of the power line 38. The three-phase coils (U-phase, V-phase, W-phase coils) of the motor 32 are connected to connection points between the paired transistors of the transistors T11 to T16, respectively. Accordingly, when a voltage is applied to the inverter 34, the ratio of the on time of the paired transistors of the transistors T11 to T16 is adjusted by the electronic control unit 50, whereby a rotating magnetic field is formed in the three-phase coils, and the motor 32 is rotationally driven.

The battery 36 is constituted as, for example, a lithium-ion secondary battery or a nickel-hydrogen secondary battery, and as described above, is connected to the inverter 34 through the power line 38. A capacitor 39 is attached to the positive electrode side line and the negative electrode side line of the power line 38.

The electronic control unit 50 is constituted as a microprocessor centering on a CPU 52, and includes, in addition to the CPU 52, a ROM 54 that stores a processing program, a RAM 56 that temporarily stores data, a flash memory, an input/output port, a communication port, and the like. Signals from various sensors are input to the electronic control unit 50 through the input port. As the signals that are input to the electronic control unit 50, for example, a rotation position Om from a rotation position detection sensor (for example, a resolver) 32a that detects a rotation position of the rotor of the motor 32, and phase currents Iu, Iv from current sensors 32u, 32v that detect phase currents of the respective phases of the motor 32 can be exemplified. A voltage Vb of the battery 36 from a voltage sensor (not shown) attached between terminals of the battery 36, a current Ib of the battery 36 from a current sensor (not shown) attached to an output terminal of the battery 36, and a voltage VH of the capacitor 39 (power line 38) from a voltage sensor 39a attached between terminals of the capacitor 39 can also be exemplified. An ignition signal from an ignition switch 60, a shift position SP from a shift position sensor 62 that detects an operation position of a shift lever 61, an accelerator operation amount Acc from an accelerator pedal position sensor 64 that detects a depression amount of an accelerator pedal 63, a brake pedal position BP from a brake pedal position sensor 66 that detects a depression amount of a brake pedal 65, and a vehicle speed V from a vehicle speed sensor 68 can also be exemplified. A switching control signal to the transistors T11 to T16 of the inverter 34, and the like are output from the electronic control unit 50 through the output port.

As the shift position SP, a parking position (P position), a reverse position (R position), a neutral position (N position), a forward position (D position), and the like are prepared.

In the electric vehicle 20 of the example configured as above, the electronic control unit 50 sets requested torque Td* requested to the drive shaft 26 based on the accelerator operation amount Acc and the vehicle speed V when the shift position is the forward position or the reverse position, and sets a torque command Tm* of the motor 32 such that the requested torque Td* is output to the drive shaft 26. Then, switching control of the transistors T11 to T16 of the inverter 34 is executed such that the motor 32 is driven with the torque command Tm*. For this reason, when the torque command Tm* of the motor 32 is a value zero, zero torque control for controlling the inverter 34 such that the torque of the motor 32 becomes zero is executed.

When the shift position SP is the neutral position, basically, a gate of the inverter 34 is cut off (all transistors T11 to T16 are turned off). Note that, even when the shift position SP is the neutral position, a counter electromotive voltage Vm that is generated with rotation of the motor 32 is higher than the voltage VH of the capacitor (power line 38), the above-described zero torque control is executed. The reason is for suppressing the occurrence of braking torque due to the counter electromotive voltage Vm in the motor 32, for protecting the inverter 34, or the like.

Here, control of the inverter 34 will be described. In the example, the inverter 34 is controlled through synchronous pulse width modulation control (PWM control) or asynchronous PWM control. The PWM control is control for adjusting the ratio of the on time of the transistors T11 to T16 with comparison of a voltage command of each phase of the motor 32 and a carrier wave (triangular wave). The synchronous PWM control is control in which a cycle of the carrier wave depends on a cycle of the voltage command of each phase of the motor 32 (a rotation speed Nm of the motor 32), and the asynchronous PWM control is control in which the cycle of the carrier wave does not depend on the cycle of the voltage command of each phase of the motor 32. For example, the asynchronous PWM control is used in a region where the rotation speed Nm of the motor 32 is equal to or lower than a threshold value Nmref, and the synchronous PWM control is used in a region where the rotation speed Nm of the motor 32 is higher than the threshold value Nmref. The threshold value Nmref is appropriately set. A carrier frequency fc that is a frequency of the carrier wave is set based on the rotation speed Nm of the motor 32 in the synchronous PWM control, and is set as described below in the asynchronous PWM control.

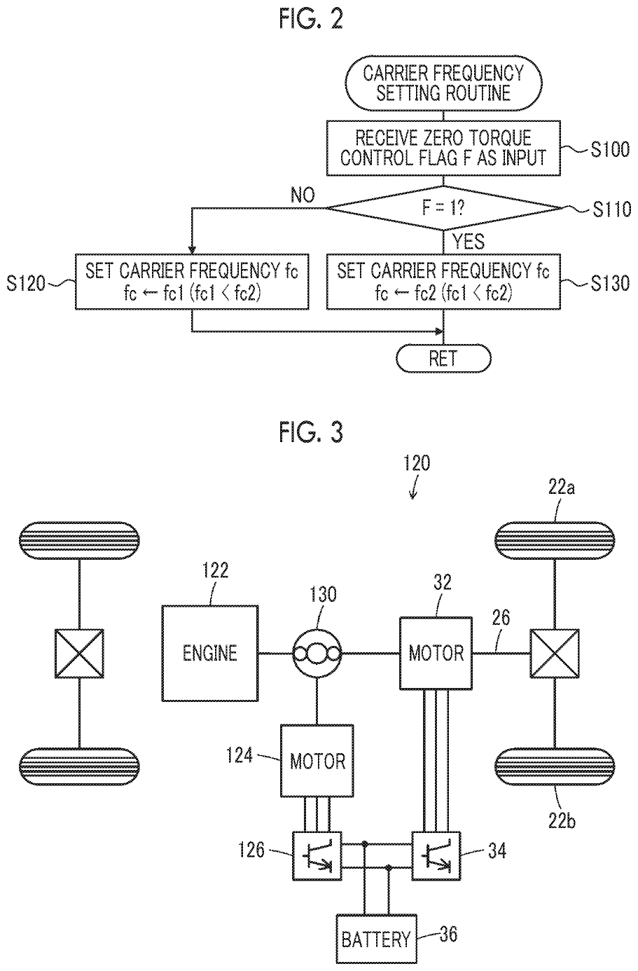

Next, the operation of the electric vehicle 20 of the example configured as above, in particular, an operation in setting the carrier frequency fc for use in the asynchronous PWM control of the inverter 34 will be described. FIG. 2 is a flowchart showing an example of a carrier frequency setting routine that is executed by the electronic control unit 50. The routine is repeatedly executed when the inverter 34 is controlled through the asynchronous PWM control.

In a case where the carrier frequency setting routine of FIG. 2 is executed, the electronic control unit 50 initially receives a zero torque control flag F as input (Step S100), and checks a value of the input zero torque control flag F (Step S110). Here, for the zero torque control flag F, a value set through a flag setting routine, which is executed in parallel with the routine, is input. In the flag setting routine, when the above-described zero torque control is executed, the zero torque control flag F is set to a value 1, and when the zero torque control is not executed, the zero torque control flag F is set to a value 0.

Then, when the zero torque control flag F is the value 0, determination is made not to execute the zero torque control, a predetermined frequency fc1 that is comparatively low is set as the carrier frequency fc (Step S120), and the routine ends. Here, the predetermined frequency fc1 is a value determined in advance as the carrier frequency fc when the zero torque control is not executed, and for example, about 4.5 kHz to 5.5 kHz is used.

In Step S110, when the zero torque control flag F is the value 1, determination is made to execute the zero torque control, a predetermined frequency fc2 that is higher than the predetermined frequency fc1 is set as the carrier frequency fc (Step S130), and the routine ends. Here, the predetermined frequency fc2 is a frequency determined in advance as the carrier frequency fc when the zero torque control is executed, and for example, a value that is about 1.5 to 2.5 times the predetermined frequency fc1 is used.

In general, when the inverter 34 is controlled through the asynchronous PWM control, the predetermined frequency fc1 that is comparatively low is used as the carrier frequency fc. The reason is for reducing loss due to the switching control of the transistors T11 to T16 of the inverter 34. Note that, as the carrier frequency fc is lower, a ripple of a current generated with the switching control of the inverter 34 increases, and sound radiation (carrier noise) is likely to increase. In particular, it is assumed that a driver is likely to feel carrier noise, which occurs when the shift position SP is the neutral position (when the driver does not intend to accelerate), as noise. With the foregoing in mind, in the example, when the asynchronous PWM control and the zero torque control of the inverter 34 are executed, the predetermined frequency fc2 that is higher than the predetermined frequency fc1 is set as the carrier frequency fc. With this, carrier noise when the zero torque control is executed can be suppressed.

In the electric vehicle 20 of the example described above, when the zero torque control for controlling the inverter 34 such that the torque of the motor 32 becomes zero is executed, the inverter 34 is controlled using the carrier frequency fc higher than when the zero torque control is not executed. With this, carrier noise when the zero torque control is executed can be suppressed.

In the electric vehicle 20 of the example, although the battery 36 is used as an electric power storage device, a capacitor may be used as an electric power storage device.

In the example, the electric vehicle 20 including the motor 32, the inverter 34, and the battery 36 has been described. Note that the present disclosure can also be applied to a hybrid vehicle including an engine in addition to the motor 32, the inverter 34, and the battery 36 or a fuel cell vehicle including a fuel cell in addition to the motor 32, the inverter 34, and the battery 36.

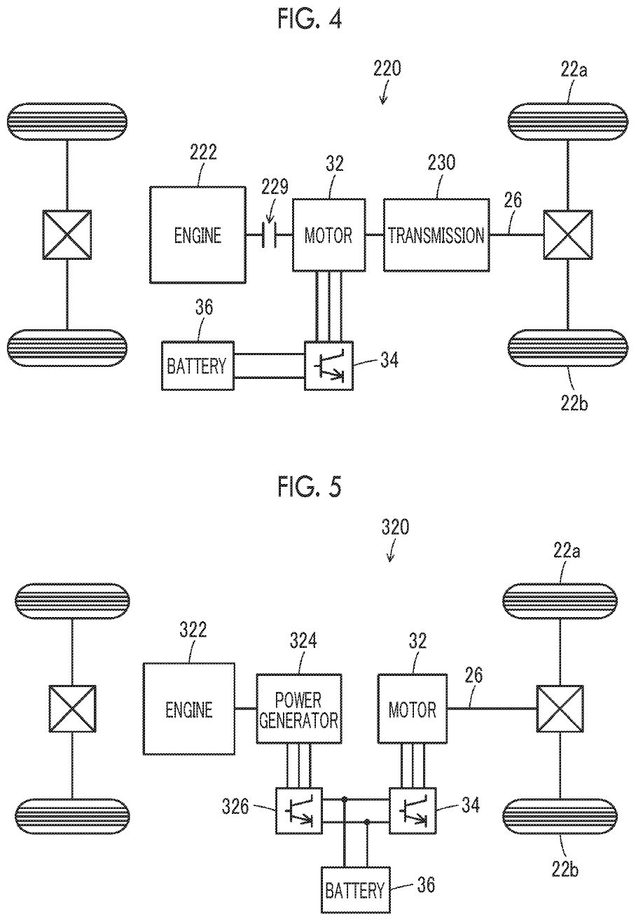

As a configuration of a hybrid vehicle, for example, as shown in a hybrid vehicle 120 of a modification example of FIG. 3, a configuration in which the motor 32 is connected to the drive shaft 26 coupled to the drive wheels 22a, 22b, an engine 122 and a motor 124 are connected to the drive shaft 26 through a planetary gear 130, and the battery 36 is connected to the motors 32, 124 through inverters 34, 126 can be exemplified. As shown in a hybrid vehicle 220 of a modification example of FIG. 4, a configuration in which the motor 32 is connected to the drive shaft 26 coupled to the drive wheels 22a, 22b through a transmission 230, an engine 222 is connected to the motor 32 through a clutch 229, and the battery 36 is connected to the motor 32 through the inverter 34 can also be exemplified. As shown in a hybrid vehicle 320 of a modification example of FIG. 5, a configuration in which the motor 32 is connected to the drive shaft 26 coupled to the drive wheels 22a, 22b, a power generator 324 is connected to an engine 322, and the battery 36 is connected to the motor 32 and the power generator 324 through inverters 34, 326 can also be exemplified. In the hybrid vehicle 120 of FIG. 3, a carrier frequency may be set on not only the inverter 34 but also the inverter 126 based on the presence or absence of the execution of the zero torque control. Here, as a case where the zero torque control is executed on the inverter 126, for example, a case where traveling is performed solely with power from the motor 32 in a state in which the engine 122 is stopped can be exemplified.

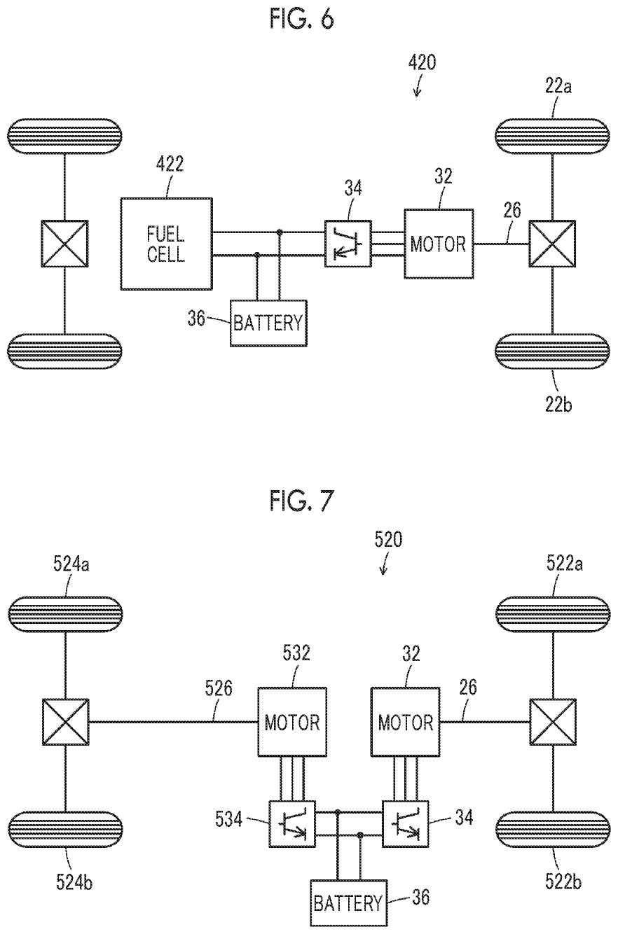

As a configuration of a fuel cell vehicle, for example, as shown in a fuel cell vehicle 420 of a modification example of FIG. 6, a configuration in which a motor 32 is connected to a drive shaft 26 coupled to the drive wheels 22a, 22b, and the battery 36 and a fuel cell 422 are connected to the motor 32 through the inverter 34 can be exemplified.

In the electric vehicle 20 of the example, although a two-wheel drive configuration has been described, the present disclosure can be applied to a four-wheel drive configuration. As a configuration of four-wheel drive, for example, as shown in electric vehicle 520 of a modification example of FIG. 7, the motor 32 is connected to the drive shaft 26 coupled to front wheels 522a, 522b, and a motor 532 is connected to a drive shaft 526 coupled to rear wheels 524a, 524b can be exemplified.

The correspondence relationship between the primary components of the example and the primary components of the present disclosure described in SUMMARY will be described. In the example, the motor 32 corresponds to a “motor”, the inverter 34 corresponds to an “inverter”, the battery 36 corresponds to an “electric power storage device”, and the electronic control unit 50 corresponds to a “control device”.

The correspondence relationship between the primary components of the example and the primary components of the present disclosure described in SUMMARY should not be considered to limit the components of the present disclosure described in SUMMARY since the example is solely illustrative to specifically describe the mode for carrying out the present disclosure. That is, the present disclosure described in SUMMARY should be interpreted based on the description in SUMMARY, and the example is merely a specific example of the present disclosure described in SUMMARY.

Although the mode for carrying out the present disclosure has been described above in connection with the example, an applicable embodiment of the present disclosure is not limited to the example, and can be of course carried out in various modes without departing from the spirit and scope of the present disclosure.

The present disclosure is usable in a manufacturing industry of a vehicle, or the like.

What is claimed is:

1. A vehicle comprising:
a motor;
an inverter configured to drive the motor;
an electric power storage device connected to the inverter through a power line; and
a control device configured to control the inverter,
wherein the control device is configured to, when zero torque control for controlling the inverter such that torque of the motor becomes zero is executed, control the inverter using a carrier frequency higher than when the zero torque control is not executed.

2. The vehicle according to claim 1, wherein the control device is configured to, when the zero torque control is executed in controlling the inverter through asynchronous pulse width modulation control, control the inverter using the carrier frequency higher than when the zero torque control is not executed.

3. The vehicle according to claim 1, wherein the control device is configured to execute the zero torque control when a shift position is a neutral position and a counter electromotive voltage generated with rotation of the motor is higher than a voltage of the power line.
